(19) United States
(12) Patent Application Publication
(10) Pub. No.: US 2018/0254737 A1
(43) Pub. Date: Sep. 6, 2018

(54) SYSTEMS AND METHODS FOR IMPROVED INSTALLATION OF CONDUITS FOR PHOTOVOLTAIC ASSEMBLIES

(71) Applicant: SUNPOWER CORPORATION, San Jose, CA (US)

(72) Inventors: Benjamin Cadbury Wong, Santa Cruz, CA (US); John Paul Kapla, Mill Valley, CA (US); Kyle Donald Feldmann, Richmond, CA (US)

(21) Appl. No.: 15/446,963

(22) Filed: Mar. 1, 2017

(51) Int. Cl. H02S 20/23; H02S 40/36; H02S 30/00

(52) U.S. Cl. CPC H02S 20/23; H02S 30/00; H02S 40/36

(57) ABSTRACT

Improved solar power systems and photovoltaic (PV) assemblies for converting solar radiation to electrical energy, and methods of installation thereof are disclosed herein. A solar power system or PV assembly can comprise a mounting structure and/or a support structure for mounting or supporting PV modules of an array. An electrical conduit or raceway along or across the support structure can transfer power output from the array. A solar power system or PV assembly can further comprise a conduit management system for managing, directing and/or elevating the electrical conduit along a power output pathway above the support surface. A conduit management system can comprise one or more conduit management devices. A conduit management device can comprise a base portion for coupling to the support surface. A conduit management device can further comprise an engagement head for reversibly engaging the electrical conduit.

### BACKGROUND

Solar power has long been viewed as an important alternative energy source. To this end, substantial efforts and investments have been made to develop and improve upon solar energy collection technology. Of particular interest are residential-, industrial- and commercial-type applications in which relatively significant amounts of solar energy can be collected and utilized in supplementing or satisfying power needs. One way of implementing solar energy collection technology is by assembling an array of multiple solar modules.

One type of solar energy system is a solar photovoltaic system. Solar photovoltaic systems (“photovoltaic systems”) can employ solar panels made of silicon or other materials (e.g., III-V cells such as GaAs) to convert sunlight into electricity. Photovoltaic systems typically include several photovoltaic (PV) modules (or “solar tiles”) interconnected with wiring to one or more appropriate electrical components (e.g., switches, inverters, junction boxes, etc.)

A typical conventional PV module includes a PV laminate or panel having an assembly of crystalline or amorphous semiconductor devices (“PV cells” or “solar cells”) electrically interconnected and encapsulated within a weather-proof barrier. One or more electrical conductors are housed inside the PV laminate through which the solar-generated current is conducted.

Regardless of an exact construction of the PV laminate, most PV applications entail placing an array of solar modules at the installation site in a location where sunlight is readily present. This is especially true for residential, commercial or industrial applications in which multiple solar modules are desirable for generating substantial amounts of energy, with the rooftop of the structure providing a convenient surface at which the solar modules can be placed. The electricity produced by the PV panels may be transmitted by electrical conduits, wires or cables from the PV panels to electrical components of the PV module system, e.g., one or more inverters. Thus, PV module systems can have substantial wiring needs. For example, each of the PV panels in an installation can connect to a neighboring one, until the entire chain is connected to a combining device and/or an inverter. The wiring of the PV module system requires proper positioning because wiring must be isolated from external structures, e.g., the roof, and loose, dangling, or slack wiring can be hazardous. Thus, a PV module system having many rows of PV panels may require a significant amount of electrical conduit mounting and mounting time, which may result in a significant fraction of the cost of installing the PV module system.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are not drawn to scale.

FIG. 1 depicts a solar power system, in accordance with an embodiment of the present disclosure;

FIG. 2 depicts a solar power system, in accordance with an embodiment of the present disclosure;

FIG. 3 depicts a conduit management device, in accordance with an embodiment of the present disclosure;

FIG. 4 depicts a conduit management device, in accordance with an embodiment of the present disclosure;

FIG. 5 depicts a conduit management device, in accordance with an embodiment of the present disclosure;

FIG. 6 depicts a conduit management device, in accordance with an embodiment of the present disclosure;

FIG. 7 depicts a conduit management device, in accordance with an embodiment of the present disclosure; and

FIG. 8 depicts a method for installing a solar power assembly comprising a conduit management system, in accordance with an embodiment of the present disclosure.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Certain terminology may be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “axial”, and “lateral” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

Terminology—The following paragraphs provide definitions and/or context for terms found in this disclosure (including the appended claims):

This specification includes references to “one embodiment” or “an embodiment.” The appearances of the phrases “in one embodiment” or “in an embodiment” do not necessarily refer to the same embodiment. Particular features, structures, or characteristics can be combined in any suitable manner consistent with this disclosure.

The term “comprising” is open-ended. As used in the appended claims, this term does not foreclose additional structure or steps.

Various units or components may be described or claimed as “configured to” perform a task or tasks. In such contexts, “configured to” is used to connote structure by indicating that the units/components include structure that performs the task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

As used herein, the terms “first,” “second,” etc. are used as labels for nouns that they precede, and do not imply any type of ordering (e.g., spatial, temporal, logical, etc.). For example, reference to a “first” encapsulant layer does not necessarily imply that this encapsulant layer is the first encapsulant layer in a sequence; instead the term “first” is used to differentiate this encapsulant from another encapsulant (e.g., a “second” encapsulant).

The terms “a” and “an” are defined as one or more unless this disclosure explicitly requires otherwise.

The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

As used herein, “inhibit” is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

As used herein, the term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present invention. The feature or features of one embodiment can be applied to other embodiments, even though not described or illustrated, unless expressly prohibited by this disclosure or the nature of the embodiments.

Improved solar power systems and PV assemblies for converting solar radiation to electrical energy and methods of installation thereof are disclosed herein. A solar power system or PV assembly can comprise a mounting structure and/or a support structure for mounting or supporting PV modules of an array. An electrical conduit or raceway along or across the support structure can transfer power output from the array. A solar power system or PV assembly can further comprise a conduit management system for managing, directing and/or elevating the electrical conduit along a power output pathway above the support surface. A conduit management system can comprise one or more conduit management devices. A conduit management device can comprise a base portion for coupling to the support surface. A conduit management device can further comprise an engagement head for reversibly engaging the electrical conduit.

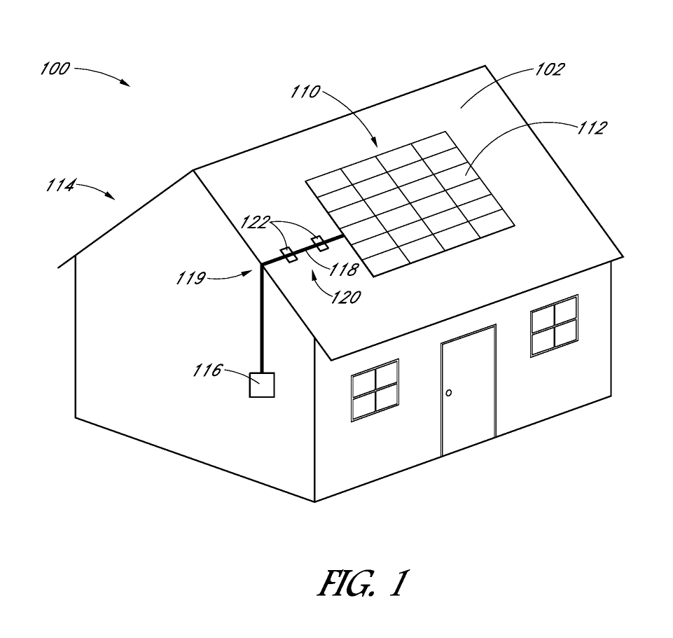

FIG. 1 is a schematic perspective view of a solar power system 100 comprising an array 110 of solar modules 112 mounted to a mounting surface 102. In some embodiments, the mounting surface 102 can be inclined or off-horizontal, such as depicted in FIG. 1. The system 100 of FIG. 1 is illustrated as being coupled to a mounting surface 102 that comprises a roof of a building, such as a residential, commercial, industrial structure, etc. There may be a superstructure under the mounting structure 102 providing support to the mounting structure 102, and which may be used to secure attachments to the mounting structure 102. For example, several rafters may support a mounting surface 102 such as the roof of a building. Additionally, the mounting surface 102 may have an interlocking layer of shingles (e.g., composite shingles, tile shingles, wooden shingles and so on) disposed on top. Additionally or alternatively, the mounting surface 102 may also include a corrugated metal (e.g., steel) roof.

The solar module 112 can include a photovoltaic (PV) laminate or panel having an assembly of crystalline or amorphous semiconductor devices (“solar cell” or “PV cells”) electrically interconnected and encapsulated within a weather-proof barrier that can include a frame. The solar modules 112 can be mounted on and coupled to spaced apart rails that extend across the mounting surface 102.

The solar power system 100 can be incorporated into an electrical system 114 connected to the array 110. The array 110 can be connected to an electrical panel or tie-in 116 of the electrical system 114 by an electrical raceway 118. The electrical raceway 118 can transfer a power output from array 110 to a load or an electrical grid. The electrical system 114 can include the array 110 as a power source connected to the electrical grid via the electrical panel 116. The electrical system 114 can also include a utility power source, a meter, an energy storage device, a monitoring device, a control device, an electrical panel with a main disconnect, a junction, electrical loads, and/or an inverter.

The electrical raceway 118 can be supported above the mounting structure 102 by a conduit management system 120 so as to transfer power generated by array 110 along a power output pathway 119 above the support surface 102. The conduit management system 120 can include several conduit management devices 122 coupled to support surface 102. Each conduit management device 122 can couple to or engage with an electrical conduit 130 of the electrical raceway 118 so as to elevate it above the mounting surface 102. Several conduit management devices 122 can be arranged or spaced apart on the inclined support surface 102 so as to elevate electrical conduit 130 along power output pathway 119. It may be preferable or even required, for example by a code or regulation, to elevate electrical conduit 130 so as to allow for heat dissipation.

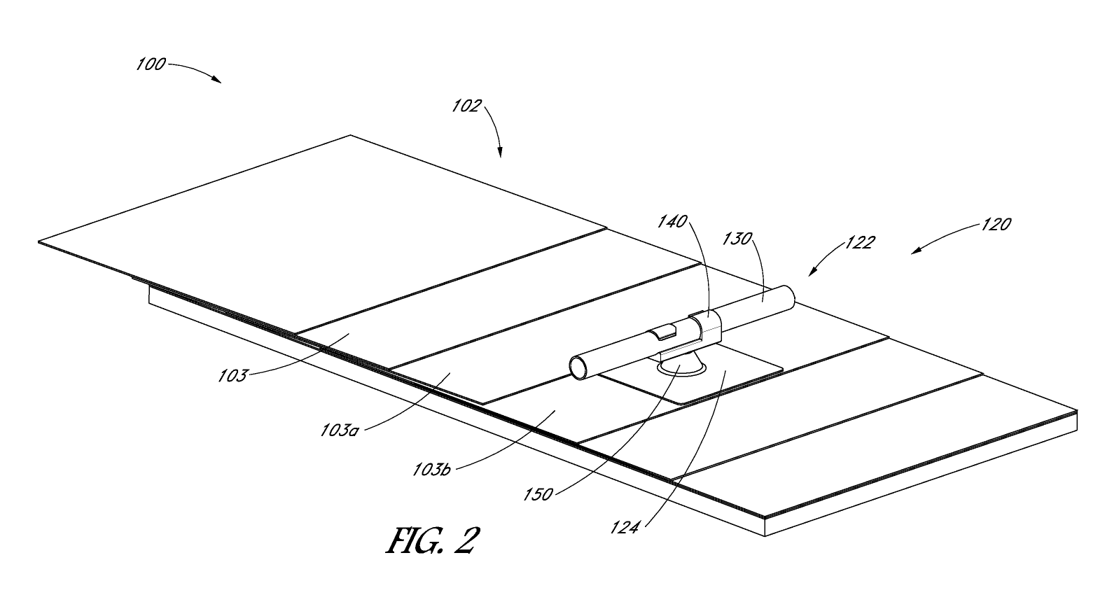

FIG. 2 depicts a magnified view of solar power system 100 comprising conduit management system 120. The mounting surface 102 can comprise several overlapping shingles 103, e.g., composite shingles, such as depicted in FIG. 2. The shingles 103 can be arranged on the inclined support surface 102 in an overlapping manner such that a first shingle row 103a overlaps a second shingle row 103b.

A portion of the electrical conduit 130 is depicted in FIG. 2. The electrical conduit 130 is configured to transfer a power output from one or more PV modules 112 of array 110. The electrical conduit 130 can comprise an electrically insulated tubing or piping (e.g., plastics, rubbers, etc.) having a central core of electrically conductive cables or wires (e.g., copper, steel, etc.). In one embodiment, the electrical conduit 130 is mechanically flexible. In another embodiment, the electrical conduit 130 can be substantially rigid.

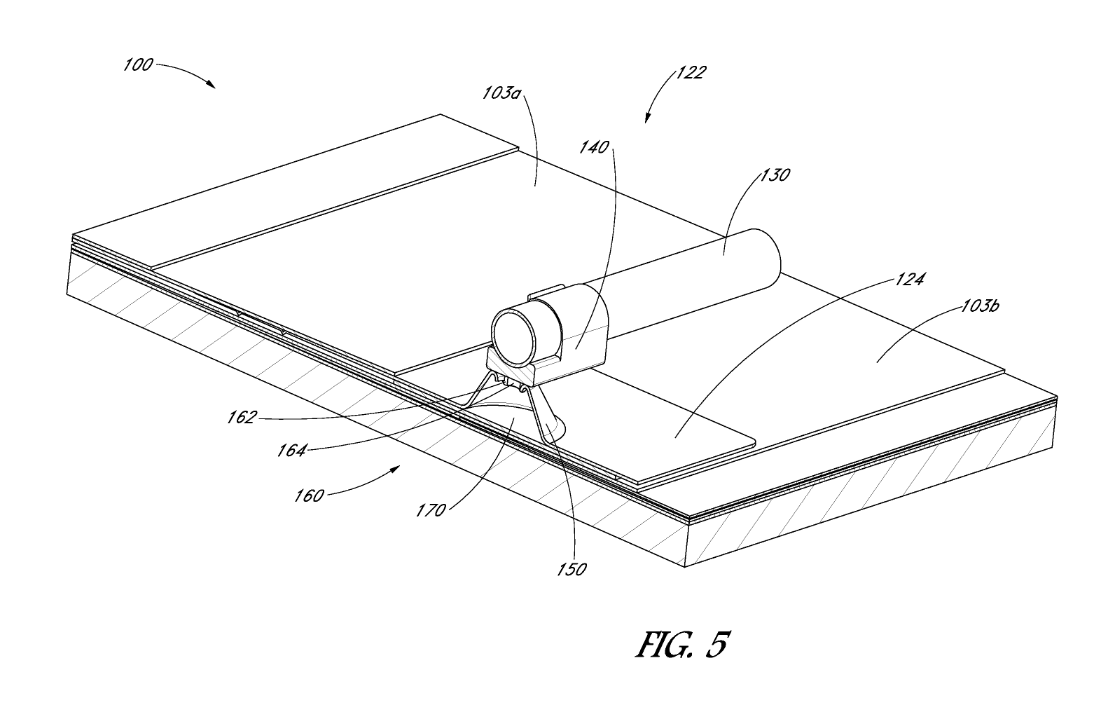

As depicted in FIG. 1 and FIG. 2, a conduit management device 122 comprises a base portion 124 for coupling to the support surface 102. The type of base portion 124 can depend in part on the type of mounting surface 102. In an embodiment, the base portion 124 can be secured under first row of shingles 130a and on top of second row of shingles 103b (also shown in FIG. 5). The base portion 124 can be configured as a flashing and secured so as to prevent moisture (e.g., precipitation, ocean spray, etc.) from penetrating the mounting structure 102. The base portion 124 may comprise metal, polymer, and/or composite materials. For example, the base portion may comprise a first type of flashing for use with a composite tile roof if the mounting surface 102 includes composite tiles. As another example, the base portion can comprise a second type of flashing for use with corrugated metal roofs if the mounting surface 102 includes a corrugated metal roofs. Alternatively, depending on the mounting surface, the base portion 124 may be installed directly on the support structure 102, for example with an adhesive or sealant.

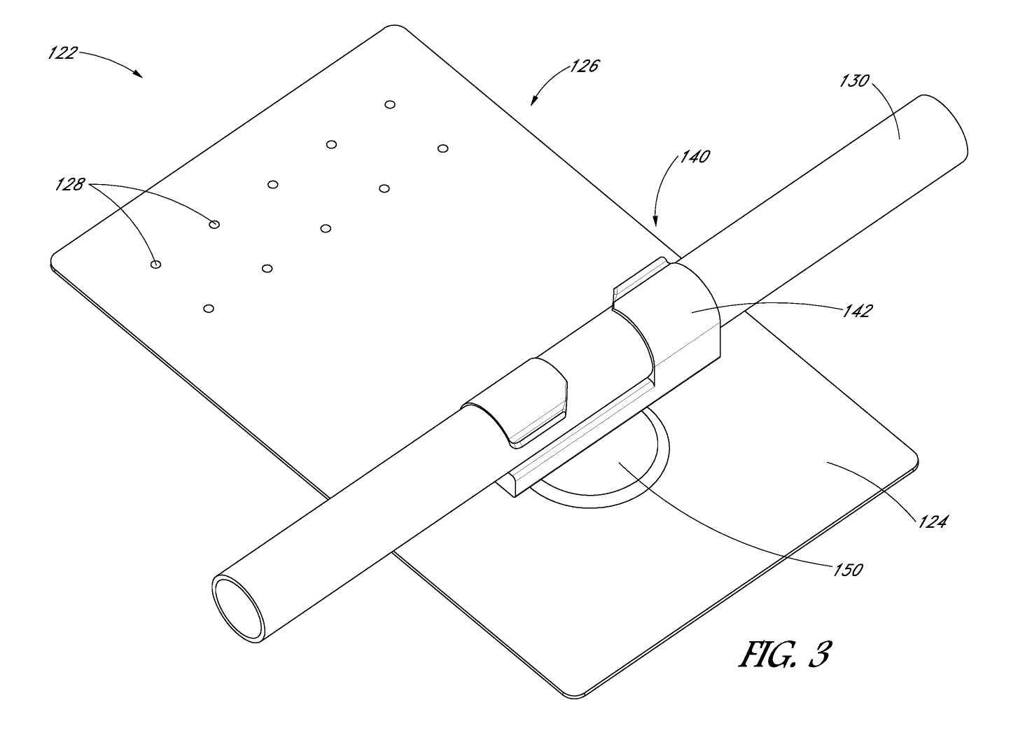

The conduit management device 122 can further comprise an engagement head 140 and an elevating portion 150 between the base portion 124 and the engagement head 140. FIG. 3 shows a magnified top down view of conduit management device 122. The base portion 124 can comprise a sheet-like or flat base portion 126 for securing or fixedly coupling to the support surface 102. For example, the flat portion 126 of the base portion 124 can be secured between overlapping rows of shingles 103. In some embodiments, the base portion 124 comprises several projecting teeth 128 for coupling to the support surface 102.

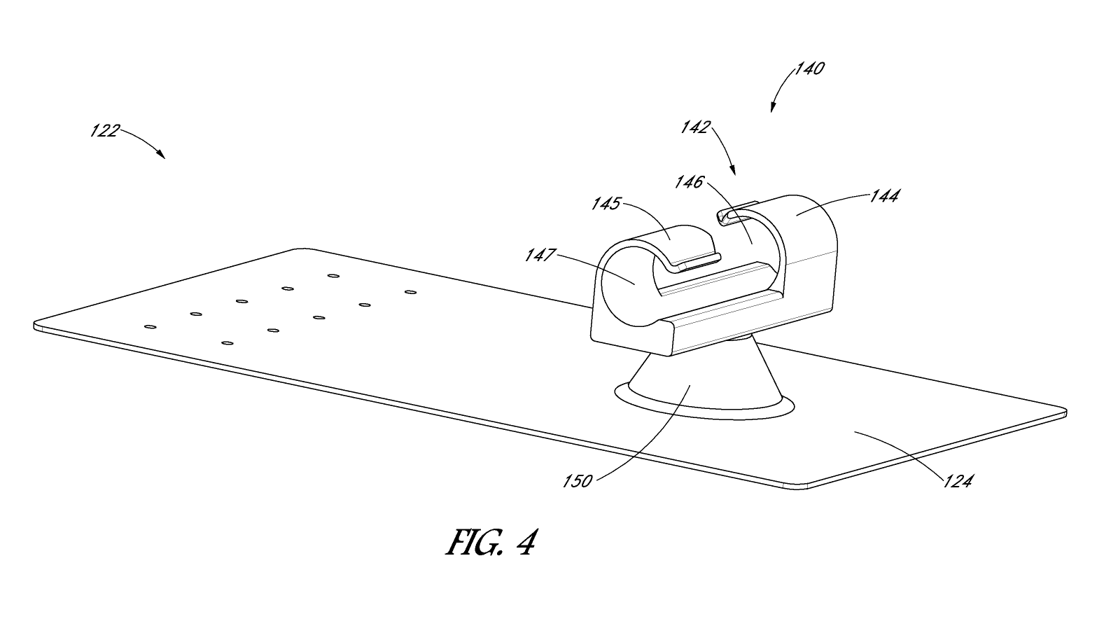

The conduit management device 122 can comprise an engagement head 140 for reversibly engaging the electrical conduit 130. FIG. 4 depicts a side view of conduit management device 122 without the conduit 130 removed for ease of description. As depicted in FIG. 3 and FIG. 4, the engagement head 140 comprises an engagement or clipping feature 142. The clipping feature 142 comprises a first clipping arm 144 having a first opening 146 on a first side of the engagement head 140 and a second clipping arm 145 having a second opening 147 on a second side of the engagement head 140. As depicted in FIG. 3 and FIG. 4, the first opening 146 is on an opposite side of the engagement head 140 from the second opening 147.

In an embodiment, the clipping feature 142 can be configured to hold or receive the electrical conduit. For example, the first and second openings 146, 147 can be configured or sized to receive the electrical conduit 130. As another example, the clipping arms 144, 145 can be partially flexible or bendable so as to yield or receive the conduit 130 on installation and then snap back or reform so as to hold the conduit in place during operation. In various embodiments, the engagement head comprises a snap-in clipping feature for reversibly engaging the electrical conduit.

FIG. 5 depicts a side cutaway view of conduit management device 122. The conduit management device 122 can comprise an elevating portion 150 for elevating the electrical conduit 130 along the power output pathway above the support surface 102. The elevating portion 150 can have any desirable height to elevate the conduit 130 above the support surface 102. For example, the elevating portion 150 can have a height between 1-10 centimeters. The elevating portion 150 can have any desirable shape or structure. For example, the elevating portion 150 can have a tapered or conical shape such as depicted in FIGS. 2-5.

In an embodiment, the engagement head 140 can be rotatable relative to the base portion 124 and/or elevating portion 150 of conduit management device 122. It may be preferable for the engagement head 140 to be configured as a rotatable feature so as to facilitate quick engagement of the electrical conduit 130, thereby enabling rapid installation of system 100. The rotatable engagement head 140 can securely fasten and/or reversibly engage the electrical conduit 130 to the conduit management device 122. For example, the electrical conduit 130 may be inserted and/or removed from rotatable engagement head 140. In one example, the rotatable engagement head 140 can be rotatable 360 angular degrees. In another example, the rotatable engagement head 140 can be rotatable less than 360 angular degrees.

In an embodiment, the conduit management device 122 can comprise a rotational feature or joint 160 configured to allow the engagement head 140 to rotate or twist relative to the base portion 124 and/or elevating portion 150. As one example, the elevating portion 150 can comprise a base joint aperture 162 located at an upper portion or end of the elevating portion 150. The rotatable clip head 140 can comprise a head joint member 164 located at a lower portion or end of the engagement head 140. The head joint member 164 can be configured or sized to fit within the joint aperture 162, thereby forming a rotatable joint 160. Any desirable structure or mechanism can be employed to allow the engagement head 140 to rotate or twist relative to the base portion 124 and/or elevating portion 150. For example, rotatable joint 160 may include a ball feature of head joint member 164 that engages a socket provided by joint aperture 162. Similarly, head joint member 164 and joint aperture 162 may be interlocking connectors forming a snap-fit when engaged. As another example, a joint member of the base or elevating portion can be configured to fit within an aperture of the engagement head.

In some embodiments, the base portion 124 and the elevating portion 150 of conduit management device 122 are integrally formed. For example, the base portion 124 and the elevating portion 150 can be integrally formed as a single piece of injection molded plastic. In other embodiments, the base portion 124 and the elevating portion 150 can be formed as an assembly of parts.

In some embodiments, the conduit management device 122 can comprise an adhesive tape or sheet 170 for coupling to the support surface 102. As depicted in FIG. 5, a back side of the base portion 124 comprises an adhesive tape or sealant 170 (e.g., butyl tape or other roofing-appropriate material) for fixedly coupling or securing the conduit management device 122 to one or more rows of shingles 103.

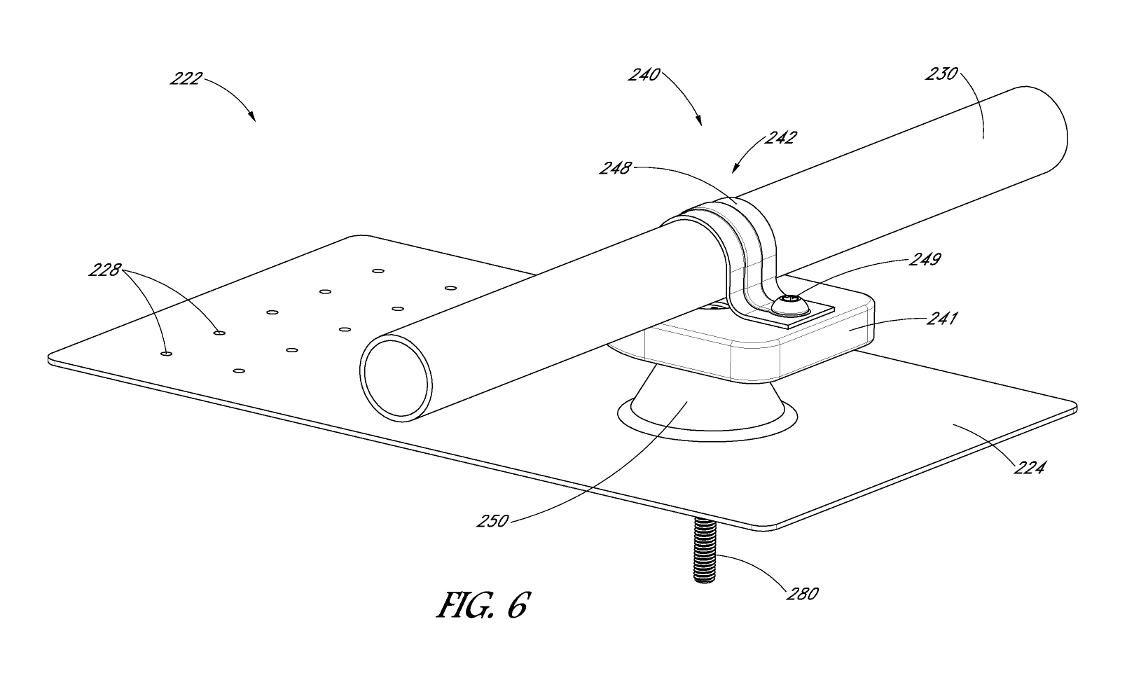

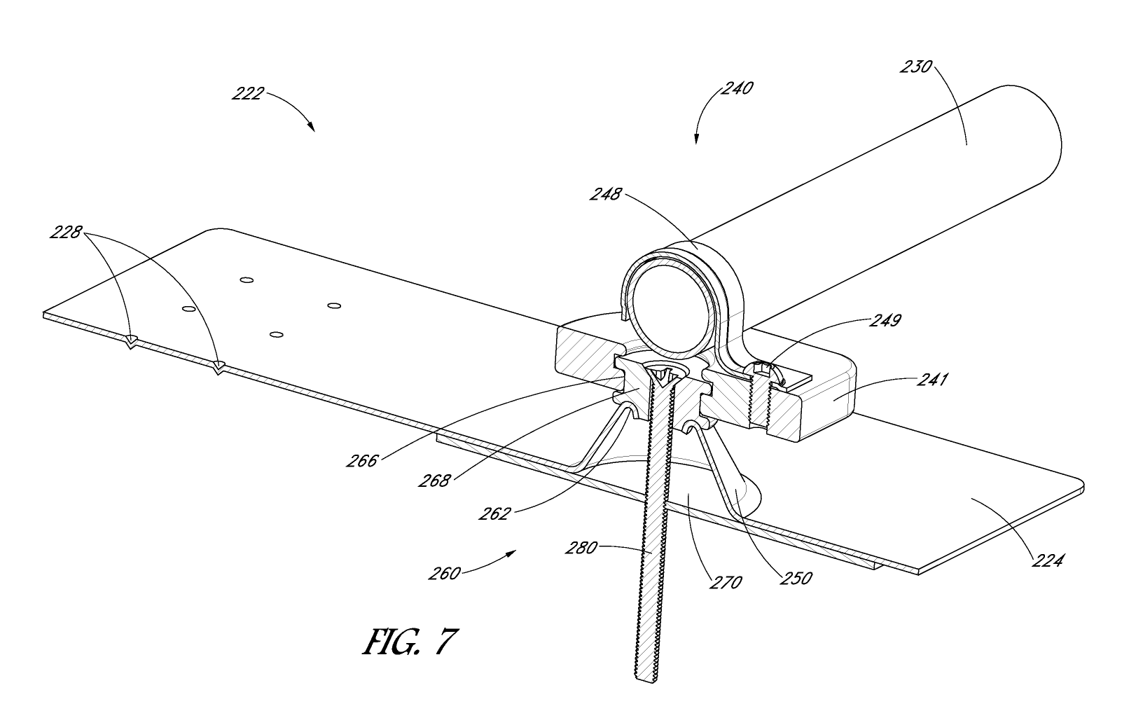

FIGS. 1-5 illustrate some embodiments of conduit management devices and related systems. Unless otherwise specified below, the numerical indicators used to refer to components in the FIGS. 6-7 are similar to those used to refer to components or features in FIGS. 1-5 above, except that the index has been incremented by 100.

FIG. 6 and FIG. 7 depict a conduit management device 222 according to another embodiment. FIG. 7 depicts a side cutaway view of conduit management device 222. The base portion 224 can comprise several projecting teeth 228 for coupling to the support surface 102. As depicted in FIG. 7, the projecting teeth 128 can be directed downward so as to engage with shingle 103.

The conduit management device 222 can comprise an engagement head 240 for reversibly engaging the electrical conduit 230. As depicted in FIG. 6 and FIG. 7, the engagement head 240 comprises an engagement or strapping feature 242. The strapping feature 242 comprises a first strap 248 secured to a lower portion 241 of the engagement head 240 with a fastener 249 (e.g., screw, bolt, etc.). As depicted in FIG. 6 and FIG. 7, the engagement head 240 comprises a single strap 248, however any desirable number of straps can be used.

In an embodiment, the conduit management device 222 can comprise a rotational feature or joint 260 configured to allow the engagement head 240 to rotate or twist relative to the base portion 224 and/or elevating portion 250. The elevating portion 250 can comprise a base joint aperture 262 located at an upper portion or end of the elevating portion 250. The rotatable clip head 240 can comprise a head joint aperture 266 located at lower portion 241 of engagement head 240. Rotational feature or joint 260 can further comprise a joint member 268 configured or sized to fit base joint aperture 262 and head joint aperture 266, thereby connecting base joint aperture 262 and head joint aperture 266 in a rotatable manner.

In some embodiments, a securing or support-penetrating device 280 can be employed to secure the conduit management device 222 to support surface 102. For example, the securing device 280 can be configured as a fastener for penetrating support surface 102 such as depicted in FIG. 6 and FIG. 7. As depicted the securing device 280 can be configured to fit rotational feature or joint 260.

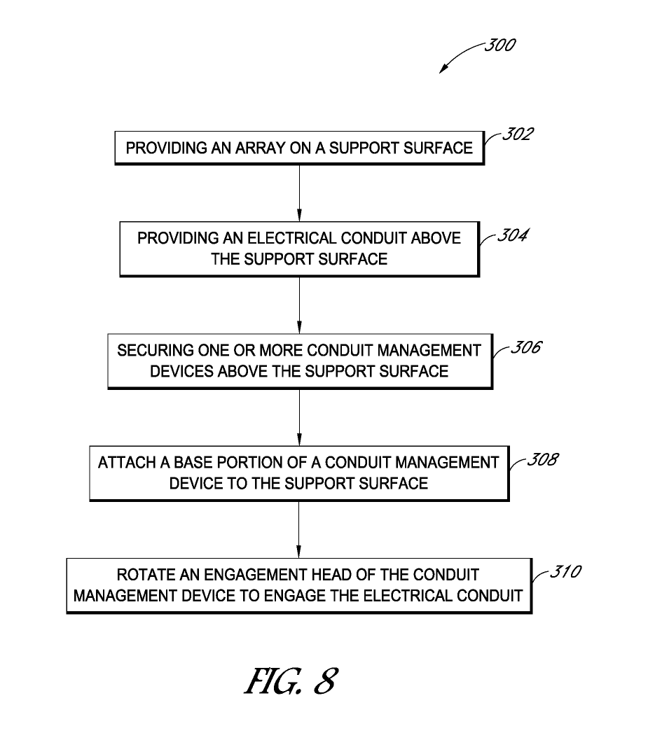

Improved methods for installing or assembling a solar power system or assembly comprising a conduit management system. FIG. 8 depicts a flowchart 300 listing operations in a method for assembling a solar power system or assembly comprising a conduit management system. Referring to operation 302 of flowchart 300, a method for installing a solar power system or assembly comprises providing a PV array on a support surface. In some embodiments, the support surface can be inclined and/or comprise composition shingles arranged in overlapping rows. The method further comprises providing an electrical conduit across a power output pathway above the support surface at operation 304.

Referring to operation 306 of flowchart 300, a method for installing a solar power system or assembly further comprises securing one or more conduit management devices on the support surface along the power output pathway. In an embodiment, the conduit management devices can be provided in a spaced apart relation. Securing a conduit management device can comprise attaching a base portion of the conduit management device to the support surface at operation 308, for example between two or more shingles of the support surface. Securing a conduit management device can further comprise rotating or twisting a rotatable engagement head of the conduit management device to securely fasten or engage the electrical conduit at operation 310, thereby elevating the electrical conduit along the power output pathway above the inclined support surface.

It will be understood that additionally or alternatively to a solar power system 100, the conduit management system 120 disclosed herein may be used to secure any of a number of other devices or fixtures to a mounting surface including but not limited to air conditioners, swamp coolers, solar water heaters, signs, lighting, antenna, communication devices, etc.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown can include some or all of the features of the depicted embodiment. For example, elements can be omitted or combined as a unitary structure, and/or connections can be substituted. Further, where appropriate, aspects of any of the examples described above can be combined with aspects of any of the other examples described to form further examples having comparable or different properties and/or functions, and addressing the same or different problems. Similarly, it will be understood that the benefits and advantages described above can relate to one embodiment or can relate to several embodiments. For example, embodiments of the present methods and systems can be practiced and/or implemented using different structural configurations, materials, and/or control manufacturing steps. The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A photovoltaic (PV) assembly comprising:
an inclined support surface comprising composition shingles arranged in overlapping rows;
a plurality of PV modules supported on the inclined support surface, the plurality of PV modules being arranged into a PV array;
an electrical conduit for transferring a power output from the PV array across a power output pathway above the inclined support surface; and
a plurality of conduit management devices fixedly coupled to the inclined support surface, each conduit management device comprising:
a base portion secured under a first overlapping row of composition shingles and on top of a second overlapping row of composition shingles;
a rotatable clip head for engaging the electrical conduit; and
an elevating portion between the base portion and the rotatable clip head;
wherein the plurality of conduit management devices are spaced apart on the inclined support surface so as to elevate the electrical conduit along the power output pathway.

2. The PV assembly according to claim 1, wherein the rotatable clip head comprises:
a first clipping arm having a first opening on a first side of the rotatable clip head;
a second clipping arm having a second opening on a second side of the rotatable clip head, the second side being opposite to the first side; and
wherein the first and second openings are sized to receive the electrical conduit.

3. The PV assembly according to claim 1, wherein the base portion and the elevating portion are integrally formed, the elevating portion having an upper portion comprising a base joint aperture; and
wherein the rotatable clip head has a lower portion comprising a head joint member sized to fit within the joint aperture, thereby forming a rotatable joint.

4. The PV assembly according to claim 1, wherein the base portion has a back side comprising an adhesive tape for securing the conduit management device to the first overlapping row of composition shingles.

5. The PV assembly according to claim 1, wherein the electrical conduit is mechanically flexible.

6. A PV conduit management system comprising:
an electrical conduit for transferring a power output from one or more PV modules supported on a support surface;
a first conduit management device comprising:
a base portion for coupling to the support surface;
an engagement head for reversibly engaging the electrical conduit; and
wherein the first conduit management device elevates the electrical conduit along a power output pathway above the support surface.

7. The PV conduit management system according to claim 6, wherein the electrical conduit is mechanically flexible.

8. The PV conduit management system according to claim 6, wherein the engagement head is rotatable.

9. The PV conduit management system according to claim 8, wherein the engagement head is rotatable 360 angular degrees.

10. The PV conduit management system according to claim 6, wherein the engagement head comprises a clipping feature.

11. The PV conduit management system according to claim 10, wherein the clipping feature comprises:
a first clipping arm having a first opening on a first side of the engagement head;
a second clipping arm having a second opening on a second side of the engagement head, the second side being opposite to the first side; and
wherein the first and second openings are sized to receive the electrical conduit.

12. The PV conduit management system according to claim 6, wherein the base portion comprises a flat portion.

13. The PV conduit management system according to claim 12, wherein the support surface is an inclined support surface comprising composition shingles being arranged in overlapping rows; and
wherein the flat portion of the base portion is secured between a first and a second overlapping row of composition shingles.

14. The PV conduit management system according claim 12, wherein the flat portion of the base portion comprises a plurality of projecting teeth for engaging the support surface.

15. The PV conduit management system according to claim 6, wherein the first conduit management device further comprises an elevating portion between the base portion and the engagement head.

16. The PV conduit management system according to claim 15, wherein the elevating portion has a height between 1 centimeters and 10 centimeters.

17. The PV conduit management system according to claim 15, wherein the base portion and the elevating portion are integrally formed as a single piece of injection molded plastic.

18. The PV conduit management system according to claim 15, wherein the elevating portion has a tapered shape.

19. A PV conduit management device for elevating an electrical conduit above an inclined support surface, the electrical conduit outputting power generated by a PV array, the PV conduit management device comprising:
a flat base portion for fixedly coupling the PV conduit management device to the inclined support surface;
a rotatable engagement head for reversibly engaging the electrical conduit;
an elevating portion between the base portion and the rotatable engagement head;
wherein the PV conduit management device elevates the electrical conduit along a power output pathway above the support surface.

20. The PV conduit management device according to claim 19, wherein the rotatable engagement head is rotatable 360 angular degrees.
